(19) United States
(12) Patent Application Publication
(10) Pub. No.: US 2003/0124269 A1
(43) Pub. Date: Jul. 3, 2003

(54) COUNTERTOP ASSEMBLY

(76) Inventor: Jeffery J. Servi, Racine, WI (US)

Correspondence Address: James E. Nilles, NILLES & NILLES, S.C., Firstar Center, Suite 2000, 777 Eastar Wisconsin Avenue, Milwaukee, WI, 53202-5345, US

(21) Appl. No.: 10/039,673

(22) Filed: Jan. 3, 2002

(51) Int. Cl. B32B 3/12

(52) U.S. Cl. 428/15; 428/116

(57) ABSTRACT

A countertop assembly having a top sheet of about 93% natural quartz material and about 7% of resins and pigments to form a stone-like sheet, with just enough resins to bind the quartz in polymeric chains. The top sheet is about 1 cm in thickness and has a honeycomb backer sheet of about 1-inch thickness and forms a lightweight core material with cell structure of vertical positioned tubular form.

### BACKGROUND OF THE INVENTION

1. Field of the Invention

This invention concerns improvements in the manufacture and construction of composite surface elements such as countertops.

2. Discussion of the Related Art

Examples of prior art composite surfaces are shown in the U.S. Pat. No. 4,973,506 issued Nov. 27, 1990, which shows a natural stone panel, and that patent also discloses a metallic honeycomb structure for supporting the said panel. U.S. Pat. No. 3,950,202 issued Apr. 13, 1976 shows a composite natural stone veneer product, having a supporting cellular honeycomb structure material. U.S. Pat. No. 3,963,846 issued Jun. 15, 1976 discloses a marble faced composite surface element of natural stone bonded to a backing consisting of a multi-cellular paper core material of substantially greater thickness. U.S. Pat. No. 4,822,661 issued Apr. 18, 1989 discloses light weight stone furniture formed of slabs of stone no greater than 1 cm in thickness.

### SUMMARY OF INVENTION

The present invention provides a countertop structure comprising a laminate of a relatively thin top sheet, on the order of 1 cm, of quartz or similar stone-like material adhesively attached to a panel of honeycomb which is covered by polyester sheeting on its upper and lower surfaces. The countertop assembly has a top sheet of about 93% natural quality material and about 7% of resins and pigments to form a stone like sheet, with just enough resins to bind the quartz in polymeric chains. This top sheet is an engineered stone that is more durable than plastic solid surfaces or other natural material. This top sheet is about 1 cm in thickness. In order to provide the necessary strength for such a relatively thin top sheet of material and particularly when the sheet is of considerable length, the present invention provides a honeycomb backer sheet of about 1 in. thickness and forming a light weight core material with cell structure of vertically positioned tubular form. The arrangement is such that a relatively thin layer of top sheet material can be used and prevented from cracking, breaking or being destroyed when it is of considerable size. The invention provides a honeycomb backer sheet of about 1 in thickness, which forms a light weight core material and is exceptionally strong. A more limited aspect of the invention relates to a non woven polyester veil cemented to opposite sides of the honeycomb backer sheet. The backer sheet is cemented on its top side to the stone-like top sheet. A phenolic backer is cemented to the underside of the honeycomb backer sheet. The result is a countertop having a relatively thin top sheet of material, which is supported by a honeycomb backer sheet and thus provides a countertop of considerable size and particularly length without cracking or breaking because of its length.

These and other objects and advantages of the present invention will occur hereinafter as this disclosure progresses.

### BRIEF DESCRIPTION OF THE DRAWINGS

FIG. 1 is a perspective, exploded view of a countertop assembly embodying the present invention, certain parts being shown as broken away or removed for the sake of clarity.

FIG. 2 is a fragmentary perspective view of the honeycomb backing structure with a portion of its top shown as broken away and removed for the sake of clarity and to show one form of hexagonal honeycomb structure.

FIG. 3 is a fragmentary, vertical cross sectional view through the countertop shown in FIG. 1 (when assembled) but on an enlarged scale.

FIG. 4 is a fragmentary perspective view of a polypropylene honeycomb with cells of circular tubular form.

FIG. 5 is a fragmentary top view of the cells shown in FIG. 4 and showing the three lines of the three orientations of the honeycomb which make its properties more uniform.

### DETAILED DESCRIPTION OF A PREFERRED EMBODIMENT

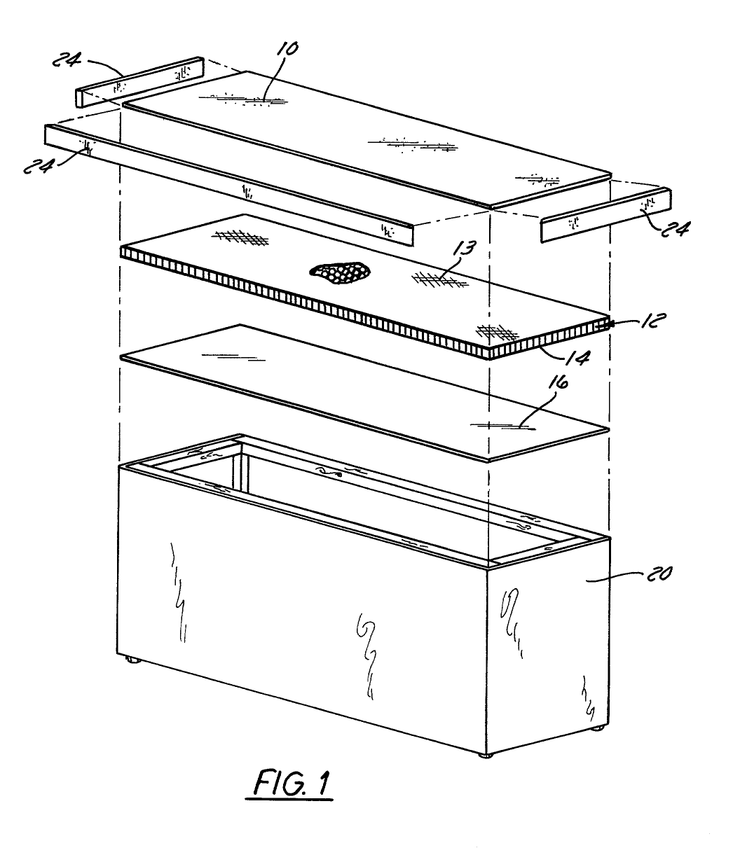

As shown in FIG. 1, the countertop 10 of natural quartz material is supported by the honeycomb structure 12 to which it is secured by sprayable contact cement 11 that is spread over the mating surfaces. This honeycomb backer structure 12 is preferably about one inch thick. The honeycomb backer structure 12 has a veil of cloth material 13 and 14 cemented to both its upper and lower sides respectively. The veils 13 and 14 are made of non-woven polyester.

Secured as being cemented by sprayable contact cement 15 to the underside of the honeycomb sheet or structure 12 is a phenolic backer 16 which is comprised of many layers of paper that are compressed and bonded together to form a rigid and hard material. The phenolic backer 16 is preferably 0.040 inches thick. This backer 16 supports the underside of the honeycomb structure and acts as a barrier against water, vapor, etc., and provides a surface for the cement 15.

The lower cabinet structure 20 is conventional and supports the above described components and countertop.

As shown in FIG. 3, the countertop material 10 extends over the edge of the honeycomb structure 12 a small distance to form a nose corner 17 that extends beyond the honeycomb structure. A separate piece 24 of countertop material extends downwardly from and is cemented to the overhanging edge of the countertop, thus to form a neat joint which is particularly strong and durable.

The present invention relates to a support structure for a countertop that is formed of natural quartz materials that are combined with resins and pigments through a process of vibro compression under vacuum. The countertop has just enough resins to bind the quartz and polymeric chains. It is comprised of 93% natural quartz material and 7% resins and pigments. This results in a top that is superior to natural and synthetic materials and has low absorption coefficient it is virtually non-porous.

Such a countertop is heavy and when used in long lengths such as 10 feet, for example, it becomes very difficult to handle and may break, because of its weight. It is desirable to manufacture this countertop in thicknesses greater than 1 cm, but that results in a structure which because of its weight cannot be used in large surface areas or lengths.

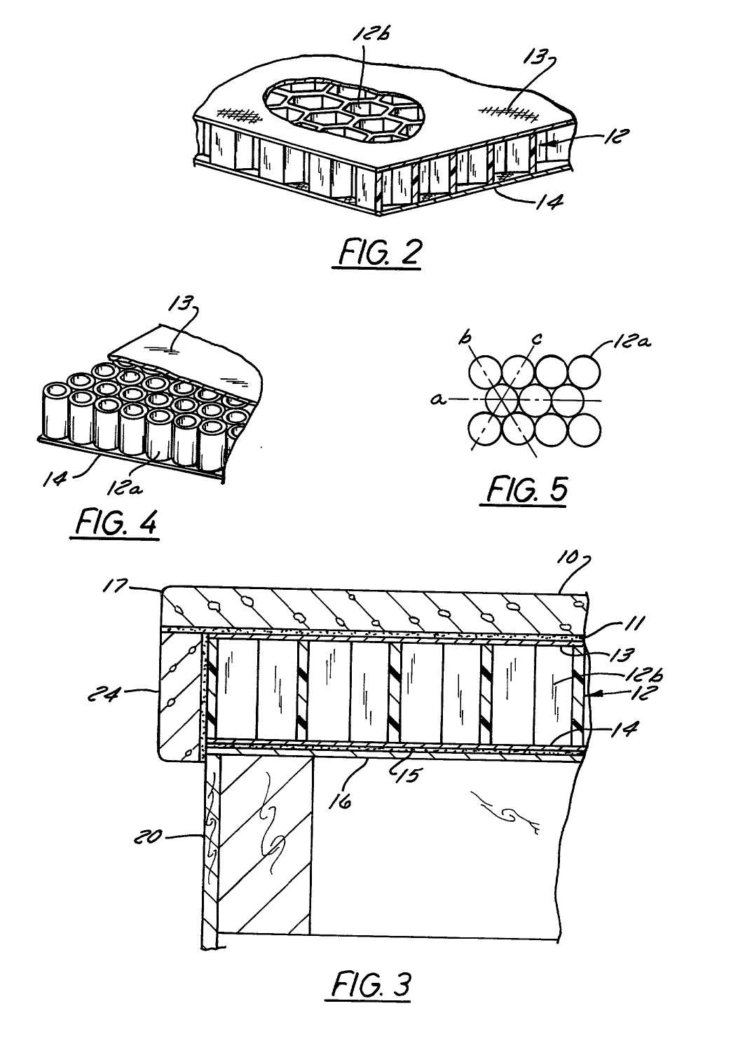

The present invention provides a means for supporting such a countertop on a fabricated backing which the permits the use of a countertop, for example, of considerable length, for example, say 10 feet. The backing is relatively lightweight yet exceptionally strong and rigid and securely and firmly supports the countertop material. The backing member itself is formed as a lightweight core material of honeycomb construction offering excellent strength and corrosion resistance. One form of such a honeycomb is made of aluminum alloy foil as shown in FIG. 2 where the cells 12b are of hexagonal cross sectional shape.

Another form of honeycomb may be made of a polypropylene honeycomb core as shown in FIGS. 4 and 5. FIG. 5 shows the three lines of orientation a, b, and c, which result in more uniform properties.

These cores have cells of generally vertical, circular cross section form and are inherently stable.

These honeycomb cores are covered on each of its upper and lower sides by a non-woven polyester veil for good bonding with adjacent surfaces. The veil forms a barrier to moisture and strengthens the top and bottom edges of the honeycomb structure.

With the present invention it is possible to use a large countertop of the above mentioned quartz material with a thickness of 1 cm and provides a strong and stable top. In order to use a material of this thickness of 1 cm, a supporting honeycomb backer sheet of 1-inch thickness provides the necessary support and rigidity regardless of the size of the countertop. On each side of the honeycomb sheet is cemented or glued the veil of cloth which is bonded to each side of the honeycomb. This veil permits the use of a sprayable contact cement for fastening the honeycomb structure directly to the underside of the countertop.

In regard to the underside of the honeycomb structure a phenolic backer 16 which is very hard and stiff is secured to the underside of the honeycomb by means of the sprayable contact cement 15. The veil which had previously been cemented to both the top and the bottom sides of the honeycomb structure acts to provide a surface on which the sprayable contact cement is applied.

The phenolic backer 16 on the underside of the honeycomb structure 12 forms a barrier against moisture and is particularly hard and rigid. The phenolic backer itself is formed of numerous sheets of paper, which are bonded together.

What is claimed is:

1. A countertop assembly comprising,
a top sheet of about 93% of natural quartz material and about 7% of resins and pigments to form a stone-like sheet, with just enough resins to bind the quartz in polymeric chains,
said sheet being one centimeter thick,
a honeycomb backer sheet of one-inch thickness and forming a lightweight core material with cell structure of vertically positioned tubular form,
a non-woven polyester veil cemented to opposite sides of said honeycomb backer sheet,
said backer sheet being cemented on its top side to said stone-like top sheet and a phenolic backer cemented to the underside of said honeycomb backer sheet.

2. The assembly of claim 1, further characterized in that said phenolic backer is comprised of a series of sheets of paper which are compressed together, said backer being about 0.040 inches thick.

3. The assembly of claim 1, further characterized in that said honeycomb backer sheet is made of a polypropylene honeycomb core and has cells of tubular form defining three lines of orientation making its properties more uniform.

4. The assembly of claim 1, further characterized in that said honeycomb backer sheet is made of an aluminum alloy foil honeycomb core having cells of hexangural cross sectional shape.

5. A countertop assembly comprising,
a top sheet of about 93% of natural quartz material and about 7% of resins and pigments to form a stone-like sheet, with just enough resins to bind the quartz in polymeric chains,
said sheet being one centimeter thick,
a honeycomb backer sheet of one-inch thickness and forming a lightweight core material with cell structure of vertically positioned tubular form,
a non-woven polyester veil cemented to opposite sides of said honeycomb backer sheet,
said backer sheet being cemented on its top side to said stone-like top sheet, a phenolic backer cemented to the underside of said honeycomb backer sheet,
said phenolic backer is comprised of a series of sheets of paper which are compressed together, said backer being about 0.040 inches thick, and
said honeycomb backer sheet is made of a polypropylene honeycomb core and has cells of tubular cross sectional form defining three lines of orientation making its properties more uniform.

6. A countertop assembly comprising,
a top sheet of about 93% of natural quartz material and about 7% of resins and pigments to form a stone-like sheet, with just enough resins to bind the quartz in polymeric chains,
said sheet being one centimeter thick,
a honeycomb backer sheet of one-inch thickness and forming a lightweight core material with cell structure of vertically positioned tubular form,
a non-woven polyester veil cemented to opposite sides of said honeycomb backer sheet,
said backer sheet being cemented on its top side to said stone-like top sheet and a phenolic backer cemented to the underside of said honeycomb backer sheet,
said phenolic backer is comprised of a series of sheets of paper which are compressed together, said backer being about 0.040 inches thick, and
said honeycomb backer sheet is made of an aluminum alloy foil honeycomb core having cells of hexangural cross sectional shape.
